(19) United States
(12) Patent Application Publication
(10) Pub. No.: US 2009/0262186 A1
(43) Pub. Date: Oct. 22, 2009

(54) ENDOSCOPE CONTROL UNIT AND ENDOSCOPE UNIT

(75) Inventors: Akifumi TABATA, Ibaraki (JP); Takaaki SHOJI, Saitama (JP); Akihiro ITO, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/426,353

(22) Filed: Apr. 20, 2009

(30) Foreign Application Priority Data
Apr. 21, 2008 (JP) 2008-109985

(51) Int. Cl. H04N 7/18

(52) U.S. Cl. 348/76; 348/E07.085

(57) ABSTRACT

An endoscope control unit including an imaging device controller and a first signal-processing circuit, is provided. The endoscope control unit orders a CMOS imaging device to capture an image and to carry out signal processing for supplying an image signal to a monitor. The CMOS imaging device generates the image signal on the basis of the captured image. The imaging device controller orders the CMOS imaging device to generate a frame's worth of image signal every first period. The first period is shorter than a second period. The image to be displayed on the monitor is refreshed every second period in order to displaying a moving image. The first signal-processing circuit outputs one frame of the image signal generated by the CMOS imaging device to the monitor every second period.

### BACKGROUND OF THE INVENTION

1. Field of the Invention

The present invention relates to reduction of rolling shutter distortion generated by an electronic endoscope having a CMOS imaging device, when capturing a moving subject.

2. Description of the Related Art

There is known an electronic endoscope with an imaging device at the head end of an insertion tube as the device for capturing a moving image. In the prior endoscope, a CCD imaging device is used. However, a lot of signal lines are necessary for driving the CCD imaging device and for transmitting the image signal generated by the CCD imaging device. Accordingly, it is difficult to reduce the diameter of the insertion tube due to the abundance of signal lines.

Japanese Unexamined Patent Publication No. H11-196332 discloses a CMOS imaging device, with lower manufacturing cost and power consumption, and with fewer signal lines needed than in a CCD imaging device. CMOS imaging devices are preferred for use in electronic endoscopes.

However, because CMOS imaging devices are driven by line exposure, rolling shutter distortion appears in the captured image of a subject if the subject is moving quickly.

### SUMMARY OF THE INVENTION

Therefore, an object of the present invention is to provide an endoscope control unit that controls a CMOS imaging device so as to capture a moving subject with reduced rolling shutter distortion, and also carries out signal processing on the image signal generated by the CMOS imaging device.

According to the present invention, an endoscope control unit comprising an imaging device controller and a first signal-processing circuit, is provided. The endoscope control unit orders a CMOS imaging device to capture an image and to carry out signal processing for supplying an image signal to a monitor. The CMOS imaging device is mounted in an electronic endoscope. The CMOS imaging device generates the image signal on the basis of the captured image. The imaging device controller orders the CMOS imaging device to generate a frame's worth of image signal every first period. The first period is shorter than a second period. The image to be displayed on the monitor is refreshed every second period in order to display a moving image. The image corresponds to one frame of the image signal. The first signal-processing circuit outputs one frame of the image signal generated by the CMOS imaging device to the monitor every second period.

Further, the first signal-processing circuit separately outputs first and second groups of pixel signals according to the interlace scan method. The image signal consists of the first and second groups of the pixel signals.

Further, the endoscope control unit comprises a third signal-processing circuit that outputs the image signal generated by the CMOS imaging device to another apparatus according to the progressive scan method, or separately outputs first and second groups of pixel signals, belonging to the same frame of the image signal, according to the interlace scan method.

### BRIEF DESCRIPTION OF THE DRAWINGS

The objects and advantages of the present invention will be better understood from the following description, with reference to the accompanying drawings in which:

FIG. 1 is a block diagram showing the internal structure of an endoscope system having an endoscope control unit of a first embodiment of the present invention;

FIG. 2 is a block diagram showing the structure of a CMOS imaging device;

FIG. 3 is a block diagram showing the internal structure of an image-processing unit of the first and third embodiments;

FIG. 4 is a timing chart illustrating the timing in generating an image signal by a CMOS imaging device and outputting the image data by an interlace output circuit in the first embodiment;

FIG. 5 is a block diagram showing the internal structure of an image-processing unit of the second embodiment;

FIG. 6 is a timing chart illustrating the timing in generating an image signal by a CMOS imaging device and outputting the image data by an interlace output circuit in the second embodiment;

FIG. 7 is a timing chart illustrating the timing in generating an image signal by a CMOS imaging device and outputting the image data by an interlace output circuit in the third embodiment; and

FIG. 8 is a block diagram showing the structure of a CMOS imaging device having a plurality of signal output lines.

### DESCRIPTION OF THE PREFERRED EMBODIMENTS

The present invention is described below with reference to the embodiment shown in the drawings.

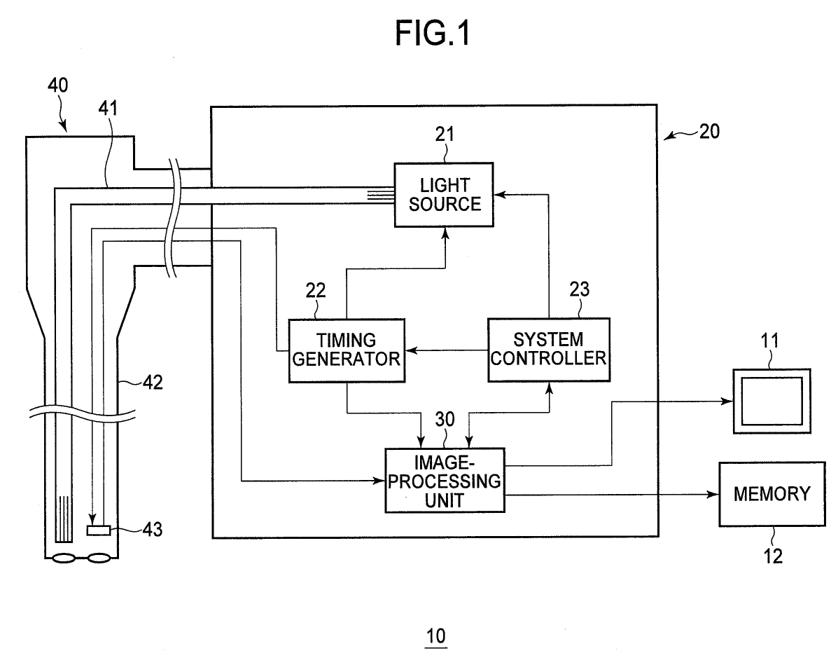

In FIG. 1, an endoscope system 10 comprises an endoscope processor 20, an electronic endoscope 40, and a monitor 11. The endoscope processor 20 is connected to the electronic endoscope 40 and the monitor 11.

The endoscope processor 20 provides the electronic endoscope 40 with illumination light shone on a subject. An optical image of the illuminated subject is captured by the electronic endoscope 40, and then the electronic endoscope 40 generates an image signal. The image signal is transmitted to the endoscope processor 20.

The endoscope processor 20 carries out predetermined signal processing on the received image signal. The image signal, having undergone predetermined signal processing, is transmitted to the monitor 11, where an image corresponding to the received image signal is displayed.

The endoscope processor 20 comprises a light source 21, an image-processing unit 30, a timing generator 22 (imaging device controller), a system controller 23, and other components. The light source 21 emits the illumination light for illuminating a desired subject forward the incident end of a light guide 41. The image-processing unit 30 carries out predetermined signal processing on the image signal, as described in detail later. The timing generator 22 times some operations of the components in the endoscope system 10. The system controller 23 controls the operations of all components in the endoscope system 10.

By connecting the endoscope processor 20 to the electronic endoscope 40, the light source 21 and a light guide 41 mounted in the electronic endoscope 40 are optically connected. Illumination light emitted by the light source 21 is transmitted to the exit end of the light guide 41, and illuminates a peripheral area near the head end of the insertion tube 42 of the electronic endoscope 40.

An optical image of the subject illuminated by the illumination light is formed on a light-receiving surface of a CMOS imaging device 43 mounted in the electronic endoscope 40. A clock signal and a trigger signal are sent to the CMOS imaging device 43 from the timing generator 22. On the basis of the clock signal and the trigger signal, the CMOS imaging device 43 generates an image signal corresponding to the optical image formed on the light-receiving surface.

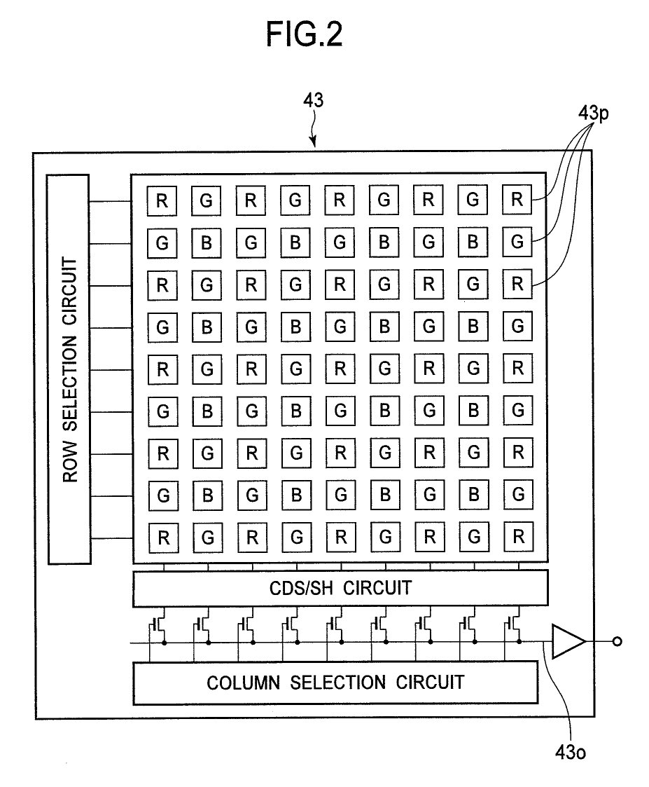

As shown in FIG. 2, on the light-receiving surface of the CMOS imaging device 43, a plurality of pixels 43p are arranged in a matrix. Each of the pixels 43p is covered with an R, G, or B color filter arranged according to the Bayer arrangement.

Each pixel generates a pixel signal according to the amount of received light which passes through the color filter covering the pixel. Pixels covered with an R, G, or B color filter generate red, green, and blue pixel signal components according to amounts of received red, green, or blue light, respectively. A frame of an image signal consists of all the pixel signals generated by the pixels 43p.

The CMOS imaging device 43 comprises one signal output line 43o. An image signal is generated and output via the signal output line 43o according to the progressive scan method, as explained in detail below. First, pixel signals are generated and output, in order, by the pixels arranged in the first row. After pixel signals from the first row are output, pixel signals are generated and output by rows, from the second to the final row.

When the CMOS imaging device 43 receives the trigger signal of the ON state, the CMOS imaging device 43 generates and outputs a frame's worth of image signal in 1/60 of a second. On the basis of the clock signal, the CMOS imaging device 43 carries out operations for generating an image signal, such as selection of the row and column of the pixel whose signal is to be output.

The trigger signal pulses from the OFF to ON state once every 1/30 second. During one half of that period ( 1/60 second), the CMOS imaging device 43 generates a frame's worth of image signal. The generated image signal is transmitted to the image-processing unit 30.

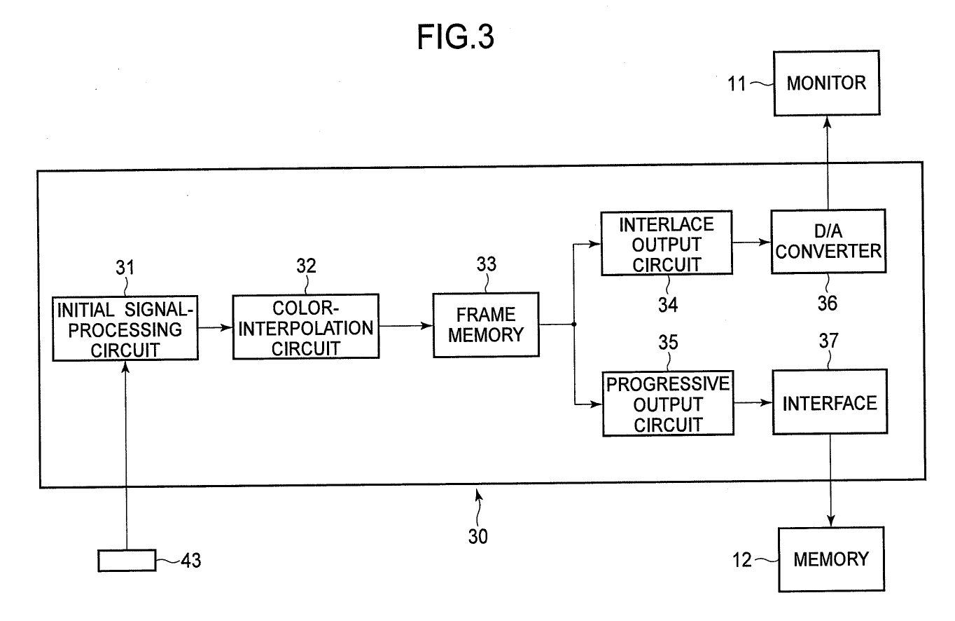

As shown in FIG. 3, the image-processing unit 30 comprises an initial signal-processing circuit 31, a color-interpolation circuit 32 (second signal-processing circuit), a frame memory 33, an interlace output circuit 34 (first signal-processing circuit), a progressive output circuit 35 (third signal-processing circuit), a D/A converter 36, an interface 37, and other components.

The image signal is transmitted from the CMOS imaging device 43 to the initial signal-processing circuit 31. The initial signal-processing circuit 31 carries out correlated double sampling and A/D conversion on the received image signal, and then the image signal is converted into digital image data.

The image data is transmitted to the color-interpolation circuit 32. As described above, each pixel data represents only one color among red, green, and blue, and does not carry information about the other two colors. The color-interpolation circuit 32 carries out color-interpolation processing, where the other color information for every pixel is complemented using the pixel data of surrounding pixels in the same frame, through interpolation. The color-interpolation circuit 32 comprises a line buffer (not depicted). The color-interpolation circuit 32 carries out color-interpolation processing using the pixel data of each row stored in the line buffer.

The image data, having undergone color-interpolation processing, is transferred to and stored in the frame memory 33. The frame memory 33 is connected to the interlace output circuit 34 and the progressive output circuit 35. The interlace output circuit 34 outputs the image data from the frame memory 33 to the D/A converter 36 according to the interlace scan method. The progressive output circuit 35 outputs the image data from the frame memory 33 to the interface 37 according to the progressive scan method. The outputs of the image data by the interlace output circuit 34 and the progressive output circuit are explained in detail below.

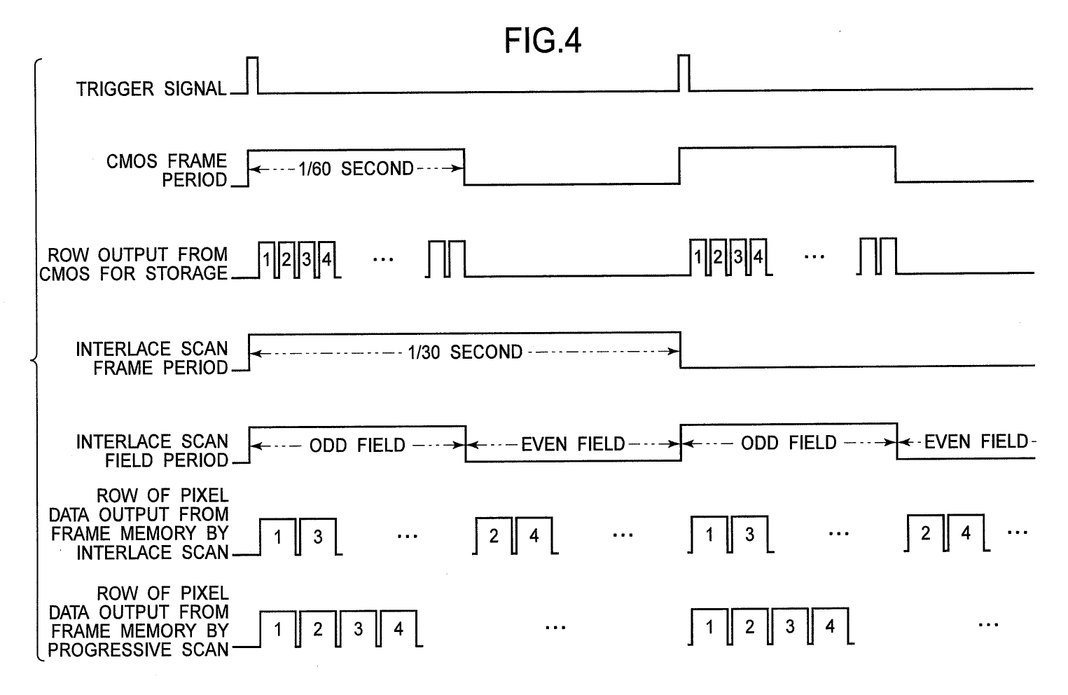

As shown in FIG. 4, the frame period (first period) of the CMOS imaging device 43 is determined to be 1/60 second. The CMOS imaging device 43 generates a frame's worth of image signal every two successive frame periods, and the frame of an image signal is stored as image data in the frame memory 33. As described above, in each frame period of the CMOS imaging device, pixel data is stored in row order in the frame memory 33 (see the trace labeled “row output from CMOS for storage”).

1/30 second, which is twice as long as the frame period of the CMOS imaging device 43, is determined to be one frame period for the interlace output circuit 34 and the progressive output circuit 35 (see the trace labeled “interlace scan frame period”). The interlace and progressive output circuits 34 and 35 output the image data stored in the frame memory 33 according to the interlace and progressive scan methods, respectively.

First and second 1/60 seconds in the frame period for the interlace output circuit 34 are designated odd and even field periods (see the trace labeled “interlace scan field period”), respectively. The interlace output circuit 34 transmits pixel data for the odd rows (first group of pixel signals) stored in the frame memory 33 to the D/A converter 36 in the odd field period. In addition, the interlace output circuit 34 transmits pixel data for the even rows (second group of pixel signals) stored in the frame memory 33 to the D/A converter 37 in the even field period. Accordingly, the pixel data for the even rows is read and transmitted by the interlace output circuit 34 before next frame of image data is stored in the frame memory 33. As explained above, in the interlace scan method, a frame's worth of image signal is output by separately outputting the pixel data corresponding to the pixels in the odd and even rows.

The pixel data for the odd and even rows is transmitted to the D/A converter 36 (see the trace labeled “row of pixel data output from frame memory by interlace scan”) at half speed where the CMOS imaging device 43 generates and outputs each pixel signal. The D/A converter 36 converts the image data of the odd and even fields into an analog image signal. The image signal is then transmitted to the monitor 11.

The progressive output circuit 35 transmits pixel data to the interface 37 at half the speed at which the CMOS imaging device 43 generates and outputs each pixel signal (see the trace labeled “row of pixel data output from frame memory by progressive scan”). The interface 37 is connectable to another apparatus, such as a memory 12, other endoscope processors 20, etc. The image data output according to the progressive scan method can thereby be transmitted to another apparatus.

In the above first embodiment, as explained in detail below, rolling shutter distortion can be reduced.

In a usual monitor, images to be displayed are refreshed at a 30 fps frame rate in which even fields and odd fields alternate every 1/60 seconds according to a standard, such as NTSC. Accordingly, image signals should be input to the monitor at 30 fps.

On the other hand, if the frame rate for the CMOS imaging device is matched to the frame rate specified for a usual monitor, such as 30 fps, the period between the output of the first and last pixel signals in a given frame period may be too long and thus distort the capture of a moving subject. As a result, rolling shutter distortion may appear in a displayed image.

In the above embodiment, the CMOS imaging device is ordered to generate an image signal at a higher frame rate than that specified for a usual monitor, and the interlace output circuit 34 outputs the image signal at a frame rate matching the one specified for the monitor. Accordingly, rolling shutter distortion is reduced by raising the frame rate of the CMOS imaging device 43 compared with that of the monitor, because the period for generating a frame's worth of image signal may be shortened while the refresh period of the monitor 11 may not.

Next, an endoscope system having an endoscope control unit of the second embodiment is explained. The primary differences between the second embodiment and the first embodiment are the method of controlling the CMOS imaging device, the structure of the image-processing unit, and the interlace scan method of the interlace output circuit. The second embodiment is explained mainly with reference to the structures and functions that differ between the two embodiments. The same index numbers are used for structures that correspond between the two embodiments.

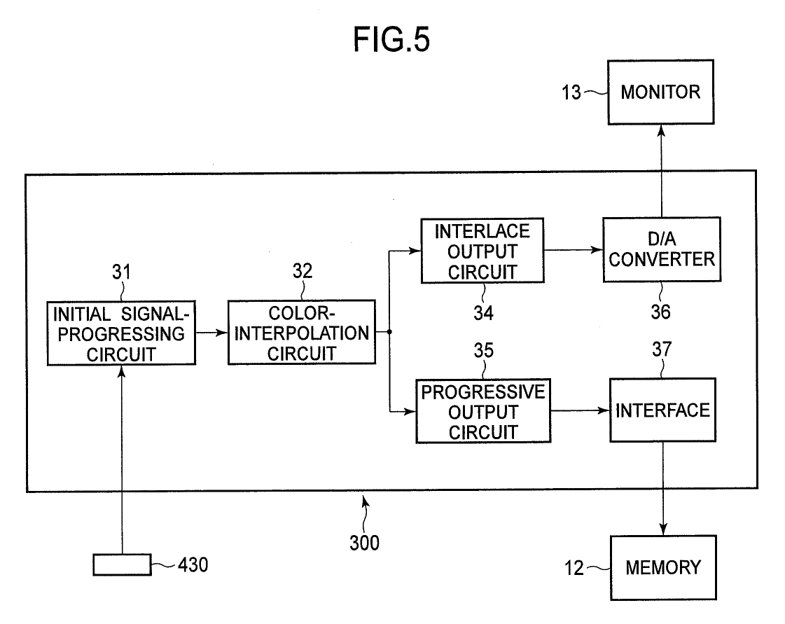

The CMOS imaging device 430 (see FIG. 5) is ordered to generate and output an image signal according to the progressive scan method, as in the first embodiment. In addition, when the CMOS imaging device 430 receives the trigger signal of ON state, the CMOS imaging device 430 generates and outputs a frame of an image signal in 1/60 second, as in the first embodiment.

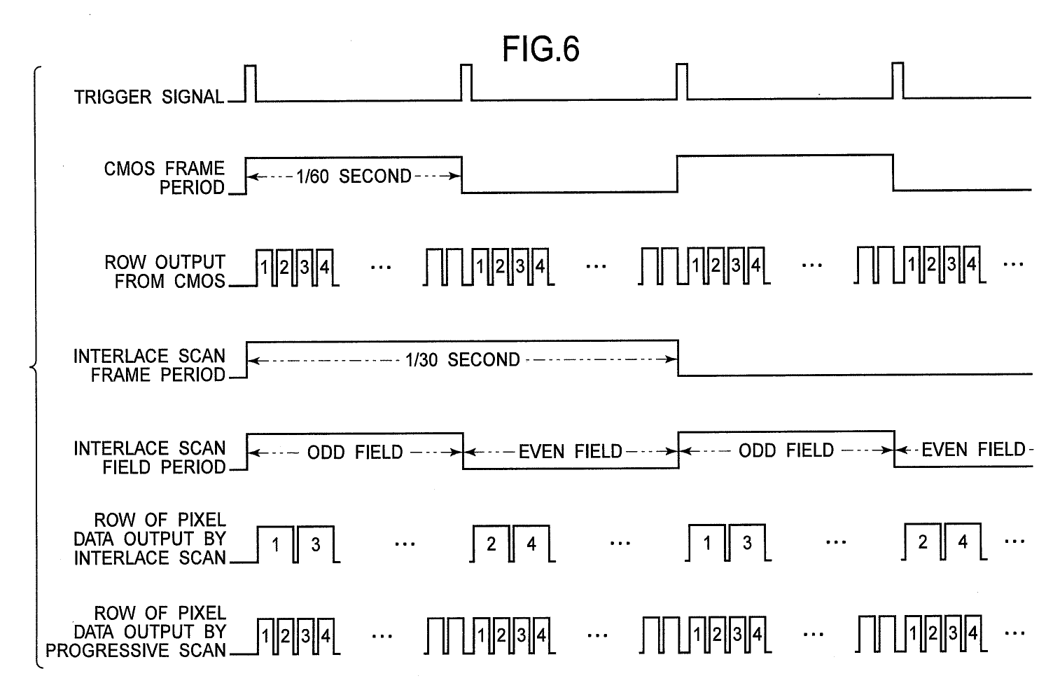

The trigger signal pulses from the OFF to ON state once every 1/60 second, unlike in the first embodiment. Accordingly, the CMOS imaging device 430 generates a frame's worth of image signal every 1/60 second. As shown in FIG. 6, a frame period of the CMOS imaging device 430 is determined to be 1/60 second. The CMOS imaging device 430 generates a frame's worth of image signal every frame period. The generated image signal is transmitted to the image-processing unit 300, as in the first embodiment.

The image-processing unit 300 (see FIG. 5) comprises an initial signal-processing circuit 31, a color-interpolation circuit 32, an interlace output circuit 34, a progressive output circuit 35, a D/A converter 36, an interface 37, and other components, as in the first embodiment. The image-processing unit 300 does not comprise a frame memory, unlike in the first embodiment.

The image signal is transmitted from the CMOS imaging device 43 to the initial signal-processing circuit 31, which carries out correlated double sampling and A/D conversion on the received image signal, as in the first embodiment. In addition, the color-interpolation circuit 32 carries out color interpolation processing, as in the first embodiment.

The image data, having undergone color-interpolation processing, is directly transmitted to both the interlace output circuit 34 and the progressive output circuit 35.

The interlace output circuit 34 outputs pixel data for only the odd rows among image data which the image-processing unit 300 receives during the odd field period (see the trace labeled “interlace scan field period” in FIG. 6), to the D/A converter 36. The pixel data for the even rows is discarded.

In addition, the interlace output circuit 34 outputs pixel data for only the even rows among image data which the image-processing unit 300 receives during the even field period, to the D/A converter 36. The pixel data for the odd rows is discarded.

The progressive output circuit 35 transmits pixel data to the interface 37 at the same speed at which the CMOS imaging device 430 generates and outputs each pixel signal (see the trace labeled “row of pixel data output from frame memory by progressive scan”).

In the second embodiment, rolling shutter distortion is reduced, because the frame rate of the CMOS imaging device 430 can be raised compared with the monitor's as the image signal can be received by a monitor. In addition, because a frame memory is unnecessary, manufacturing cost can be reduced.

Next, an endoscope system having an endoscope control unit of the third embodiment is explained. The primary differences between the third embodiment and the first embodiment are the speed of the CMOS imaging device used to generate an image signal, the image signal used for interlaced output, and the speed of the interlaced output comparing to the speed of image signal generation. The third embodiment is explained mainly with reference to the structures and functions that differ from those of the first embodiment. Here, the same index numbers are used for the structures that correspond to those of the first embodiment.

In the third embodiment, the CMOS imaging device 43 is ordered to generate and output an image signal according to the progressive scan method, as in the first embodiment. In the third embodiment, the CMOS imaging device 43 generates and outputs a frame of an image signal in 1/120 second when receiving the trigger signal of ON state, unlike in the first embodiment. In the third embodiment, 1/120 second is determined to be one frame period of the CMOS imaging device 43.

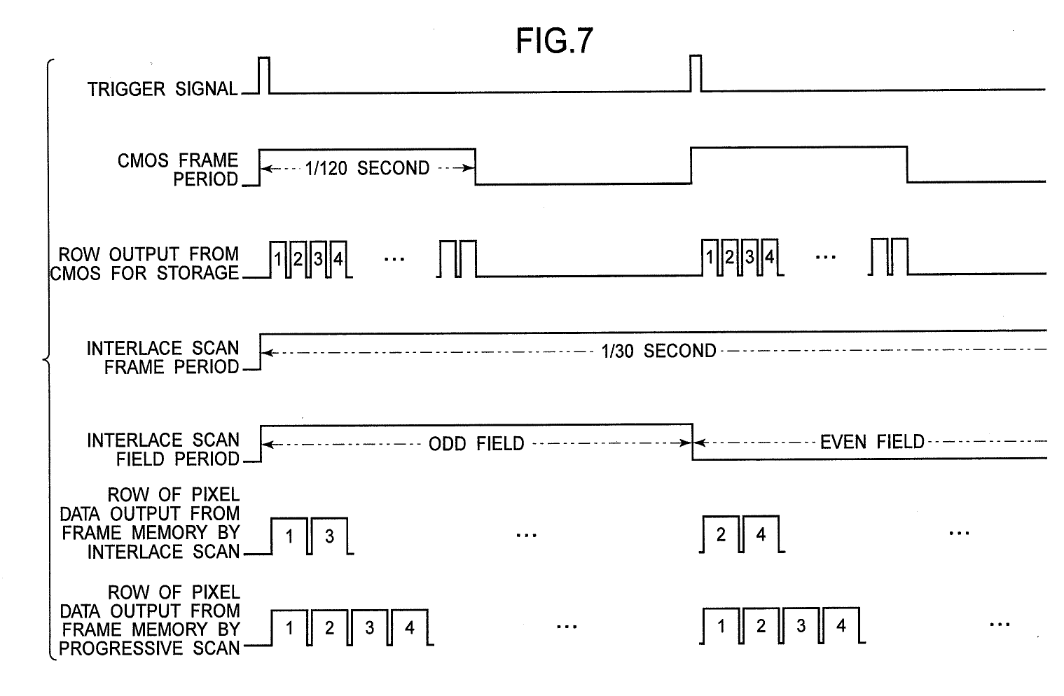

The trigger signal pulses from the OFF to ON state once every 1/60 second, unlike in the first embodiment. During one half of that period ( 1/120 second), the CMOS imaging device 43 of the third embodiment generates a frame's worth of image signal (see FIG. 7). The generated image signal is transmitted to the image-processing unit 30.

The image-processing unit 30 carries out correlated double sampling, A/D conversion, and color-interpolation processing on the received image signal, and the image data is stored in the frame memory 33, as in the first embodiment.

The first and second 1/60 seconds in the frame period for the interlace output circuit 34 are designated odd and even field periods, respectively, as in the first embodiment (see the trace labeled “interlace scan field period”). And the interlace output circuit 34 transmits pixel data for the odd rows stored in the frame memory 33 to the D/A converter 36 in the odd field period. In addition, the interlace output circuit 34 transmits pixel data for the even rows stored in the frame memory 33 to the D/A converter 37 in the even field period.

When the pixel data for even rows is transmitted, the next frame of image data is stored in the frame memory 33, unlike in the first embodiment. Accordingly, pixel data for odd rows in one frame of image data and pixel data for even rows in different frames of image data, are output according to the interlace scan method.

The pixel data for the odd and even rows is transmitted to the D/A converter at a quarter of the speed at which the CMOS imaging device 43 generates and outputs each pixel signal (see the trace labeled “row of pixel data output from frame memory by interlace scan”).

In the above third embodiment, rolling shutter distortion is reduced, because the frame rate of the CMOS imaging device 43 can be raised compared with that of the monitor. In addition, in the third embodiment, because a frame's worth of image signal is generated at twice the speed of the first embodiment, rolling shutter distortion is further reduced.

The ratio of the frame period of the CMOS imaging device 43 and 430 to that of outputting image signals to the monitor (second period), which is as long as the frame period for the interlace output circuit 34, hereinafter referred to as an input-to-output ratio, is ½, in the first and second embodiments. In the third embodiment, the input-to-output ratio is ¼. However, the input-to-output ratio is not limited to ½ or ¼. The same effect can be achieved as long as the input-to-output ratio is greater than 0 and less than 1. In other words, as long as the frame period for outputting image signals to a monitor is shorter than that for the CMOS imaging device, rolling shutter distortion can be reduced, as in the first to third embodiments.

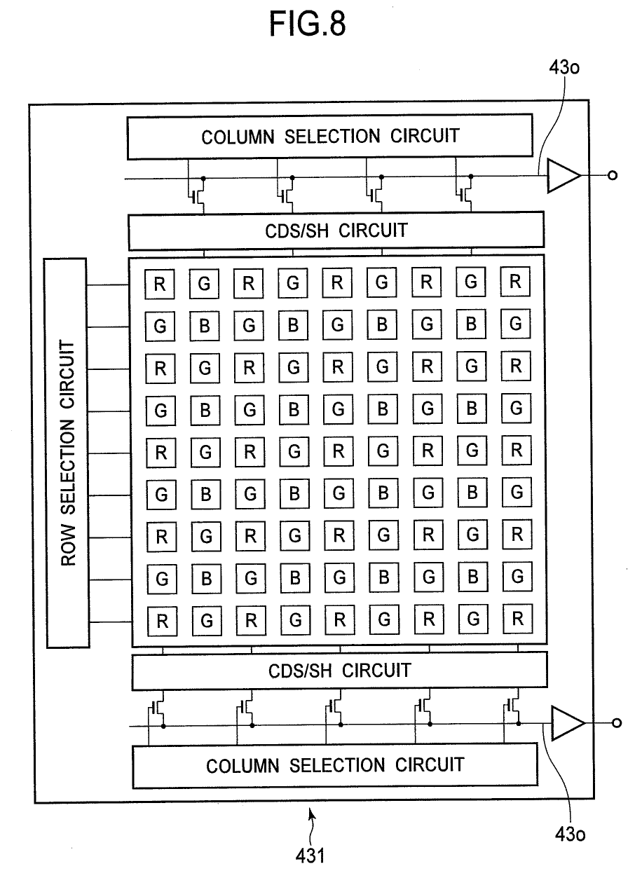

The frame period of the CMOS imaging device 43 and 430 can be shortened by raising the frequency of the clock signal, in the first to third embodiments. In addition, the frame period of the CMOS imaging device can be shortened by using a CMOS imaging device 431 having a plurality of signal output lines 43o as shown in FIG. 8.

Following color-interpolation processing, the interlace output circuit 34 outputs the image data according to the interlace scan method, in the first to third embodiments. However, color-interpolation processing can also be carried out on image data output according to the interlace scan method. By carrying out color-interpolation processing before outputting the image data according to the interlace scan method in the first to third embodiments, color interpolation processing can be carried out on each pixel data using the pixel data of the neighboring rows. Accordingly, color can be more accurately reproduced in a displayed image.

The image data is transmitted to another apparatus via the interface 37 according to the progressive scan method, in the first to third embodiments. However, the image data can be transmitted to another apparatus according to the interlace scan method, or, the image data might not be transmitted. The rolling shutter distortion can be reduced as long as the image data is transmitted to the usual monitor according to the interlace scan method regardless of the method of outputting the image data to another apparatus or whether output to another apparatus even occurs. If the image data is transmitted to another apparatus according to the interlace scan method, it is preferable that the pixel data which is output, have odd and even fields that belong to the same frame.

The frame period for the progressive output circuit 34 is determined to be 1/30 second in the first embodiment and 1/60 second in the second and third embodiments. However, the frame period for the progressive output circuit 34 is not limited to 1/30 or 1/60 second.

The frame period for the interlace output circuit 34 is twice as long as that for the CMOS imaging device 430, in the second embodiment. However, the frame period for the interlace output circuit 34 can be an even number of times as long as that for the CMOS imaging device 430.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2008-109985 (filed on Apr. 21, 2008), which is expressly incorporated herein, by reference, in its entirety.

1. An endoscope control unit, the endoscope control unit ordering a CMOS imaging device to capture an image and to carry out signal processing for supplying an image signal to a monitor, the CMOS imaging device being mounted in an electronic endoscope, the CMOS imaging device generating the image signal on the basis of the captured image, the endoscope control unit comprising:
an imaging device controller that orders the CMOS imaging device to generate a frame's worth of image signal every first period, the first period being shorter than a second period, the image to be displayed on the monitor being refreshed every second period in order to display a moving image, the image corresponding to one frame of the image signal; and
a first signal-processing circuit that outputs one frame of the image signal generated by the CMOS imaging device to the monitor every second period.

2. An endoscope control unit according to claim 1, wherein the first signal-processing circuit separately outputs first and second groups of pixel signals according to the interlace scan method, the image signal consisting of the first and second groups of the pixel signals.

3. An endoscope control unit according to claim 2, wherein the same frame of the image signal consisting of the first and second groups of the pixel signals.

4. An endoscope control unit according to claim 3, further comprising a second signal-processing circuit that carries out color-interpolation processing on the pixel signals of the second group using pixel signals of the first group in the same frame of the second group before the first signal-processing circuit outputs pixel signals of the second group.

5. An endoscope control unit according to claim 2, wherein,
the second period is an even number of times as long as the first period, and
the first and second groups of the pixel signals are comprised of different image signals which are separately received by the first signal-processing circuit when the first and second groups of the pixel signals are to be output, respectively.

6. An endoscope control unit according to claim 5, further comprising a second signal-processing circuit that carries out color-interpolation processing on the pixel signals of the second group using pixel signals of the first group in the same frame of the second group before the first signal-processing circuit outputs pixel signals of the second group.

7. An endoscope control unit according to claim 1, further comprising a third signal-processing circuit that outputs the image signal generated by the CMOS imaging device to another apparatus according to the progressive scan method, or separately outputs first and second groups of pixel signals, belonging to the same frame of the image signal, according to the interlace scan method.

8. An endoscope control unit according to claim 1, wherein the CMOS imaging device can simultaneously output a plurality of pixel signals that the image signal comprises.

9. An endoscope unit, comprising:
a CMOS imaging device that is mounted in an electronic endoscope, the CMOS imaging device generating an image signal on the basis of a captured image;
a monitor on which an image corresponding to the image signal is displayed;
an imaging device controller that orders the CMOS imaging device to generate a frame's worth of image signal every first period, the first period being shorter than a second period, the image to be displayed on the monitor being refreshed every second period in order to display a moving image, the image corresponding to one frame of the image signal; and
a first signal-processing circuit that carries out first signal processing on the image signal so that one frame of the image signal generated by the CMOS imaging device is output to the monitor every second period.
